(19) United States
(12) Patent Application Publication
(10) Pub. No.: US 2013/0257807 A1
(43) Pub. Date: Oct. 3, 2013

(54) SYSTEM AND METHOD FOR ENHANCING TOUCH INPUT

(71) Applicants: Elliott Harris, San Francisco, CA (US); Robert Michael Chin, San Francisco, CA (US)

(72) Inventors: Elliott Harris, San Francisco, CA (US); Robert Michael Chin, San Francisco, CA (US)

(73) Assignee: Apple Inc., Cupertino, CA (US)

(21) Appl. No.: 13/438,808

(22) Filed: Apr. 3, 2012

(51) Int. Cl. G06F 3/041

(52) U.S. Cl. CPC G06F 3/0418
USPC 345/175; 345/178

(57) ABSTRACT

Disclosed herein are systems, methods, and non-transitory computer-readable storage media for processing user input. A system configured to practice the method first receives, via a touch screen of a computing device, input from a user. Then the system fetches data associated with the input from at least two sensors other than the touch screen and adjusts an input processing algorithm based on the input and the data to yield an adjusted input processing algorithm. Then the system can process the input according the adjusted input processing algorithm. The adjusted input processing algorithm can estimate a velocity of the input and/or filter out invalid inputs. The other sensors besides the touch screen can be an accelerometer, a gyroscope, a microphone, a Hall Effect sensor, a compass, an ambient light sensor, a proximity sensor, a camera, and/or a positioning system. The data can relate to the input based on a temporal relationship.

### BACKGROUND

1. Technical Field

The present disclosure relates to enhancing touch input and more specifically to improving velocity estimations of a touch input using data from sensors.

2. Introduction

Touch-sensitive mobile devices, such as smart phones and tablets, can run an increasingly sophisticated array of applications and developers are constantly finding new ways to use the available capabilities of such devices. One category of application for these mobile devices allows a user to play virtual instruments displayed on a touch screen, such as a piano, drum, cymbal, or guitar. However, in order to accurately recreate the virtual instruments, the developer must be able to recreate the input sensitivities that are often an integral aspect of a music composition. For example, when a musician plays a piano and the musician hits a piano key softly, the musician expects the instrument to produce a quiet sound. Alternatively, when the musician applies more force to the piano key, the musician expects the instrument to produce a louder sound. Thus, when the musician plays a virtual instrument, the musician expects the virtual instrument to replicate the input sensitivities of the physical instrument. Through these variations in force, a musician is able to create expressive sounds and music compositions. Unfortunately, in many cases, a musician playing a virtual instrument is significantly constrained because many touch sensitive mobile devices are not pressure sensitive.

These same types of problems arise in other categories of applications as well, such as art applications or even games. For example, in painting the type of brush stroke used significantly alters the resulting composition. One aspect of creating variation in brush strokes is through the amount of force or pressure applied to the paintbrush. If an art application is unable to replicate brush stroke sensitivities, the composition of any virtual painting will be significantly limited. These sacrifices may lead to a less than optimal user experience and applications that are not as rich and capable as the user or developer would like them to be.

One approach to address these limitations is to simulate a pressure sensitive touch screen through the use of a built-in accelerometer. However, this approach still has limited accuracy because the velocity calculation is based on data from only a single dimension, the z-axis. Furthermore, this approach has a high overhead due to the need to estimate the direction of gravity and apply low-pass and high-pass filtering.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

This disclosure provides methods of reading data from hardware connected to a touch sensitive device, such as accelerometer, gyroscope, and magnetometer, to improve velocity estimations and thereby enhance playing characteristics of a virtual device in an application running on a touch-sensitive device. The touch-sensitive device can detect a current state, including a resting position and angles of that position, and can adjust performance characteristics of the virtual device. Further, the touch-sensitive device can detect the presence of a magnet within a particular type of case or cover via a Hall Effect sensor, magnetometer, or other sensor. For example, the touch-sensitive device can detect when a case is being used on the touch-sensitive device based on the corresponding shielding effect because a compass is not able to function properly.

In another aspect, the touch-sensitive device utilizes data from an accelerometer and data from a gyroscope to estimate velocity input on the virtual instrument via the touch screen. The accelerometer and gyroscope can filter out unwanted velocity input values. In yet another aspect, the touch-sensitive device scales velocity of inputs based on user playing characteristics. For example, if a system detects that a user wants to play a quiet passage, the system will keep all values in a quiet range and not allow volume outliers that exceed a desired volume threshold. The system can incorporate a detector velocity curve. The disclosure discusses these concepts in terms of an example musical instrument application running on a mobile device, but these principles can be applied to other types of applications, devices, and form factors.

Disclosed are systems, methods, and non-transitory computer-readable storage media for processing user input. A system configured to practice the method receives, via a touch screen of a computing device, input from a user and fetches data associated with the input from at least one sensor other than the touch screen. The sensor other than the touch screen can include an accelerometer, a gyroscope, a microphone, a Hall Effect sensor, a compass, an ambient light sensor, a proximity sensor, a camera, a magnetometer, and a positioning system. The data can be associated with the input based on a temporal relationship and the system can optionally weight the data. For example, the weighting can be according to a temporal distance from the input, i.e. how far apart in time the input is away from the data associated with the input. The input can be a touch input and can include various descriptive information such as a size, area, and/or shape of the touch input and rate of change of the touch input.

Then the system can adjust an input processing algorithm based on the input and the data to yield an adjusted input processing algorithm, and process the input according to the adjusted input processing algorithm. The adjusted input processing algorithm can estimate a velocity of the input and/or filter out invalid inputs. The input can then control the application, such as by playing a virtual instrument, controlling a game, and so forth. Processing the input according the adjusted input processing algorithm includes mapping the input to one of a range of input velocities. The system can process the input and/or adjust the input processing algorithm according to a user interface element, a type of user interface element, and/or metadata associated with the user interface element to which the input is directed. Thus, the system can process input differently for different user interface elements or types.

In one variation, the touch screen is not pressure-sensitive. The user directs the input to a currently running application that simulates pressure-sensitive input, and the adjusted input processing algorithm estimates a pressure and/or a velocity of the input on the touch screen based on the data without an actual reading of pressure or velocity.

The touch-sensitive device can identify a device position category for the system based on the data and select a predefined input processing algorithm as the input processing algorithm according to the device position category. The touch-sensitive device can select the predefined input processing algorithm prior to adjusting the input processing algorithm. The device position category can include horizontal, vertical, with an attached cover, without a cover, and/or a range of angles.

Because some sensors are extremely sensitive, the system can identify a first position of the touch input on the touch screen and identify a distance and/or direction from the touch input to a sensor, such as a gyroscope. Based on the direction and distance between the touch input and the sensor, the system can weight the data from that sensor. For example, a forceful touch input that occurs very near to or directly over the gyroscope may register as a much stronger reading than a similarly forceful touch input occurring far away from the gyroscope. Accordingly, the position of the touch input on the touch sensitive display can influence how the system interprets, weights, and/or uses the sensor data. The system can perform a separate weighting based on the distance and direction for each individual sensor based on each respective sensor's position within the device.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example touch screen interaction;

FIG. 3 illustrates an example touch screen device with an accelerometer;

FIG. 4 illustrates a graph of an example input received from a sensor;

FIG. 5 illustrates an example of a location of a touch input with respect to a sensor location;

FIG. 6 illustrates an example touch screen interaction involving multiple fingers;

FIG. 7 illustrates an example touch screen device in an exemplary device position category;

FIG. 8 illustrates an example progression over time of a touch input;

FIG. 9 illustrates a first exemplary velocity curve;

FIG. 10 illustrates a second exemplary velocity curve;

FIG. 11 illustrates a block diagram of some components of an example touch screen device; and

FIG. 12 illustrates an example method embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

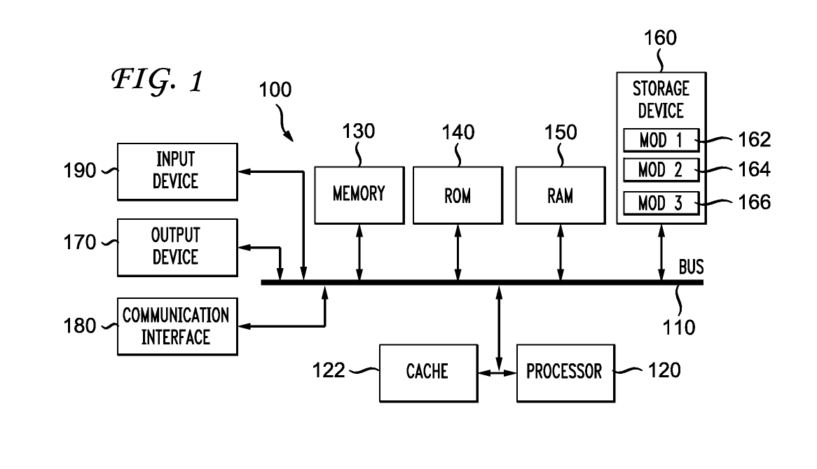

The present disclosure addresses the need in the art for enhancing touch screen input. A system, method and non-transitory computer-readable media are disclosed which process user input, taking in to consideration data from multiple sensors to enable enhancements to the user input. A brief introductory description of a basic general purpose system or computing device is presented in FIG. 1, which can be employed to practice the concepts disclosed herein. Variations shall be discussed herein as the various embodiments are set forth. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

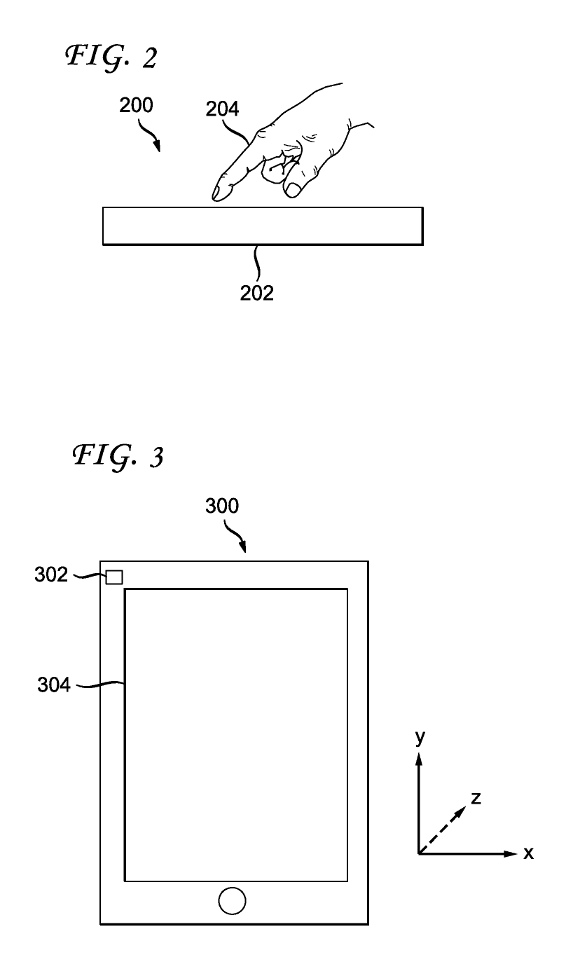

Having disclosed some components of a computing system, the disclosure now returns to a discussion of processing user input on a touch screen. FIG. 2 illustrates an example touch screen interaction 200. A portable device 202, such as a smartphone or a tablet computing device, can incorporate a touch sensitive screen, such as a capacitive or a resistive touch screen. A user can interact directly with a touch sensitive portable device 202 by touching the screen with one or more fingers 204 or other body parts, a stylus, or with other suitable objects based on the type of touch screen.

When a user touches the screen, the user applies a certain amount of pressure to the device, which alters the position of the device in three-dimensional space, even if the pressure applied is minimal. Various hardware sensors installed in the device can perceive the change in the device's position. The data from these sensors can then be used to infer an amount of pressure applied and thereby estimate a velocity of the touch input, even if the device does not include a pressure sensor. By combining data from multiple sensors, a more accurate estimated velocity can be calculated thereby resulting in a more realistic and better user experience.

The most commonly used sensor in simulating pressure applied by a touch input is an accelerometer. FIG. 3 illustrates a touch sensitive device 300. The touch sensitive device includes an accelerometer 302. The accelerometer can detect changes in the device's position in three-dimensional space along the x-, y-, and z-axes. As illustrated in FIG. 3, the z-axis runs perpendicular to the surface of the touch screen 304. The accelerometer 302 can output a value for each axis at periodic intervals, such as every millisecond.

To estimate velocity using the accelerometer 304, a processor can accept outputted values from the accelerometer 304 corresponding to the z-axis. The z-axis can be selected because it corresponds to the direction in which a user will touch the screen. That is, when a user interacts with a touch sensitive device the user can apply pressure into the screen, which can have the effect of changing the device's position in three-dimensional space along the z-axis. The processor can perform a number of calculations on the outputted accelerometer values to generate an estimated velocity value. The calculations can include high-pass filtering, low-pass filtering, and finding the slope of each value relative to the previous value.

To improve the accuracy of the estimated velocity value, the processor can also incorporate data from one or more additional sensors. One such sensor can be a gyroscope, which can be incorporated into the device to detect a change in orientation within three-dimensional space. A gyroscopic sensor can detect 3-axis angular acceleration around the x-, y-, and z-axes. This enables precise calculation of yaw, pitch, and roll. In other words, a gyroscope is able to detect microscope rotations of a device. For example, if a user touches the top center of the screen, the pressure applied could cause the device to rotate, thus shifting the orientation of the device by a number of degrees. The size of the orientation change can vary with the amount of pressure applied.

Like the accelerometer, the gyroscope can output a value for each axis at periodic intervals, such as every millisecond. Based on the change in orientation over time, the processor can simulate the amount of pressure applied and estimate the velocity of the touch input. For example, if the orientation changes significantly over a very short period of time, it is likely that the user applied more pressure, than if there was only a microscopic change in the orientation. To estimate velocity using the gyroscope, a processor can accept outputted values from the gyroscope and then perform a number of calculations on the outputted values. Based on the calculations the processor can generate an estimated velocity value.

The combination of data from an accelerometer and a gyroscope can provide information about the device's 6-axis movement in space. As described above, the processor can use data from the accelerometer to generate an estimated velocity. Likewise, the processor can use data from the gyroscope to generate an estimated velocity. However, by combining the data, the processor can generate more accurate estimated velocity values. The manner in which the data from the two sensors is combined can vary with the configuration of the system.

In some configurations, the processor can generate two independent estimated velocity values: one based on the accelerometer data and one based on the gyroscope data. The processor can then combine these values to generate a final estimated velocity value. For example, the processor could compute the average of the two values. Additionally, the processor can apply one or more weights to the independent estimated velocity values so that the weighted velocity value contributes more or less to the final estimated velocity value.

The processor can also combine the data from the two sensors by using the gyroscope data to filter the accelerometer data. As described above, in generating an estimated velocity value based solely on accelerometer data, the processor can improve the accuracy by applying high-pass and/or low-pass filtering to eliminate outlier data points or data points that result from other movements of the device. However, by incorporating the data from the gyroscope, the processor no longer needs to apply the expensive high-pass and low-pass filtering algorithms. For example, an important factor in the estimated velocity calculation can be the direction of gravity. When estimating velocity based solely on data from an accelerometer, the direction of gravity also has to be estimated. However, due to the properties of a gyroscope, the direction of gravity can actually be known. This makes it possible to filter out invalid input more accurately then through the use of high-pass and low-pass filtering algorithms.

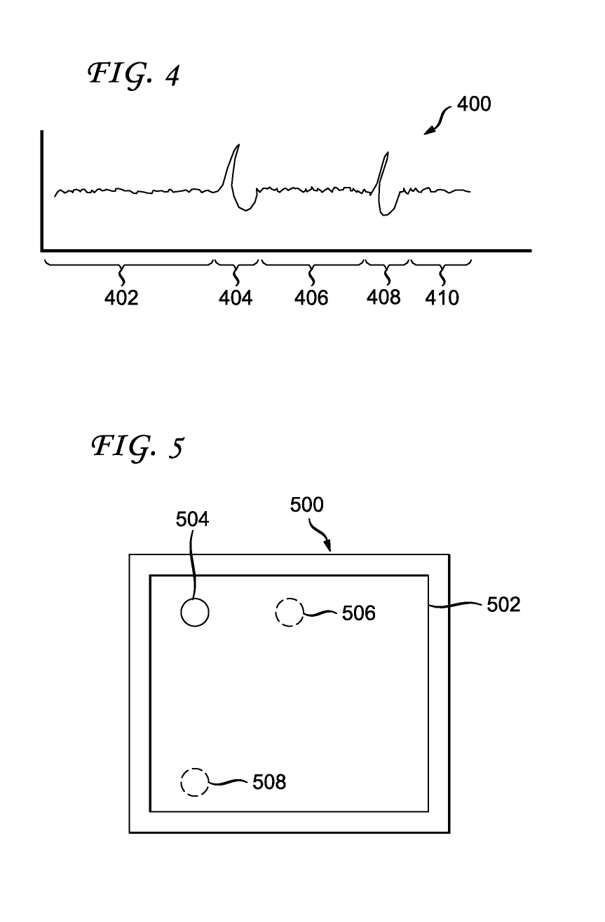

FIG. 4 illustrates a graph 400 of example input received from a sensor. Through the use of a gyroscopic sensor, the system can filter out sensor input that does not correspond to a touch input or that does not rise above a noise threshold. The graph 400 shows three relatively flat regions 402, 406, 410 that do not rise above a noise threshold. The system can ignore or scale accelerometer data from those flat regions because they are more likely to correspond to device movement than to a touch input. A first significant sensor input region 404 and a second significant sensor input region 408 each rise above the noise threshold. Based on this data, the system may infer that a touch input has occurred at region 404 and 408 and thus make use of accelerometer data from the corresponding time period.

In some cases, the system can incorporate a minimum temporal threshold between the touch input and an identified significant sensor input region, such as input regions 404 and 408. For example, the system can only consider significant sensor inputs beginning between 1 and 40 milliseconds after the beginning of a touch input. The exact range of this temporal threshold can be determined based on the sensitivity, accuracy, and/or polling intervals of the sensors, or other factors.

The system can also incorporate location data to determine what kind of sensor noise to filter and what noise threshold to set. For example, if location information indicates that the user is in a subway station, the system can dynamically set the noise threshold for the accelerometer to filter out shaking motions from the surrounding subway station caused by a subway car pulling in or out of the station.

Additionally, in some configurations, a user customizable threshold can be set to make the estimated velocity values more or less sensitive to movement. For example, a user who has a health condition that causes the user to shake while holding the device or to have movements that are more rigid may wish to adjust the noise threshold to accommodate the user's needs.

Data from additional sensors can also be incorporated to aid in estimating the amount of pressure applied and/or the velocity of the touch input. Such sensors can include a Hall Effect sensor, a compass, an ambient light sensor, a proximity sensor, a magnetometer sensor, and a positioning system sensor. Exemplary uses of alternative sensors will be further discussed below.

In calculating the velocity of a touch input a variety of factors can influence how the device responds to and how the sensors perceive the touch input. These factors can include these size and/or shape of the device, the placement of a motion detecting sensor, the location of the touch input with respect to a sensor, whether an object is resting on the touch screen when the touch input occurs, and/or the type of case that is on the device. Furthermore, the estimated velocity can be influenced by other factors such as the change in size of the touch input and/or the touch input history.

The shape of the device can impact the accuracy of an estimated velocity value. For example, many touch sensitive devices have a curved back. Thus, when a user taps a corner of the device, the change in the device's position will likely be greater than a similarly applied touch to the center of the device. Likewise, if the touch sensitive device has a flat back and it is lying on a smooth table, even a rather forceful touch input is unlikely to cause much movement in the device.

To account for such variations, the processor can apply a scaling factor or a weight to any sensor data that is sensitive to shape variations. In some cases, the scaling factor or weight can be a predefined value. For example, the value can be defined per device model. Alternatively, the value can be defined to correspond to particular device characteristics, such as a weight for all curved back devices or all flat back devices, or even all curved back devices of a particular size. The scaling factor or weight can be built into the device, such as a value built into the gyroscope. Alternatively, the scaling factor or weight can be part of a software component, such as a library installed on the device, or specific to the application requesting the estimated velocity value.

The location of a touch input with respect to a sensor location can also lead to variations in sensor data for touch inputs having like pressure applications. FIG. 5 illustrates an example of variation resulting from differing touch input locations with respect to a sensor location. On a device 500 having a touch sensitive screen 502 and a sensor 504, a user provides a first touch input at point 506. The sensor 504 can detect a change in orientation of the device caused by the input. The change can be a change from a first orientation to a second orientation, or the change can be from a first orientation to a second and then back to the first. The change in orientation results in the sensor 504 producing a first change data. The user can then provide a second touch input at point 508. Again the sensor 504 can detect a change in orientation caused by the input and produce a second change data. However, because the second touch input occurred at a location that is a greater distance from the sensor the first and the second change data may differ. For example, if sensor 504 is a gyroscope, the change in orientation, as perceived by the gyroscope, may be larger for the touch input at point 508 as opposed to point 506. Alternatively, if sensor 504 is an accelerometer, the reading may be larger for the touch input at point 506 as opposed to point 508.

To account for variations resulting from the position of the touch input with respect to a sensor, the system can apply a scaling factor or a weight. That is, the system can weight the input accordingly to compensate and/or normalize the reading. For example, when processing the touch input, the system can weight the input based on the input's distance from the sensor 504. The system can assign these weights based on the location of the touch input, the location of the sensors, the positioning of these locations relative to the entire device 500, the type of device, data describing the touch input, and so forth. The touch input can be at a single point, or can be a touch and drag gesture or a flick gesture, meaning that the touch input changes location over time. Accordingly, the system can change the weights assigned to specific sensor readings dynamically over time. Furthermore, different weights can be applied to different sensors. For example, a first weight can be applied to an accelerometer sensor while a second weight can be applied to a gyroscopic sensor.

In some cases, the scaling factor or weight can be a predefined value. For example, the value can be defined per device model or sensor model. The scaling factor or weight can be built into the device, such as a value built into the gyroscope. Alternatively, the scaling factor or weight can be part of a software component, such as a library installed on the device, or specific to the application requesting the estimated velocity value.

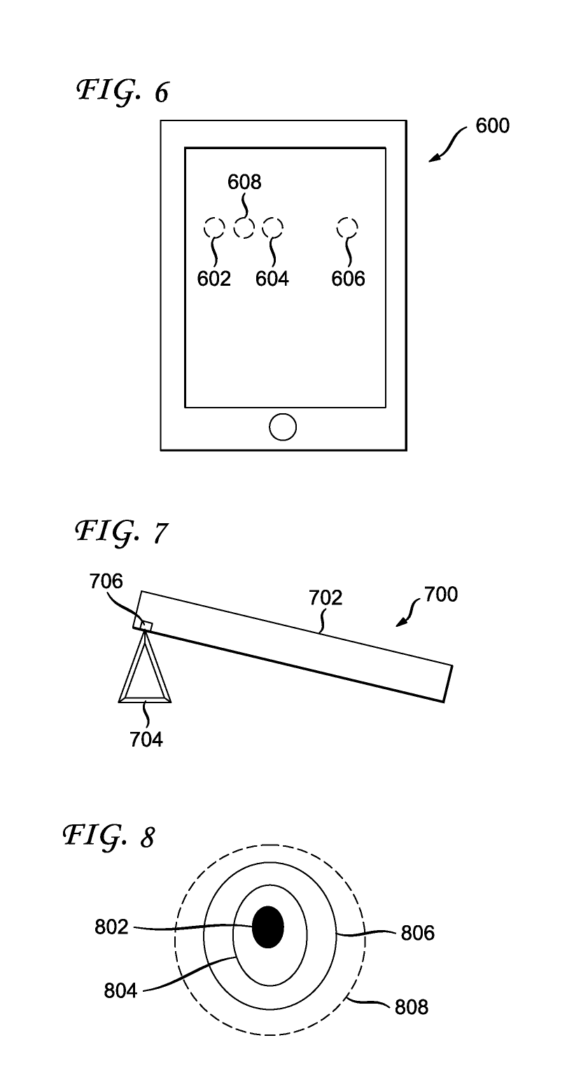

There are many applications in which a user may perform a touch input with one finger while one or more other fingers remain resting on the touch screen. For example, when playing a virtual keyboard a user may be holding down a key while playing another key with another finger. FIG. 6 illustrates a touch sensitive device 600 in which a user has tapped the touch sensitive device on a touch-screen display with a finger while two other fingers are resting on the touch screen. The user's fingers are resting on positions 602 and 604. The user then taps on position 606 on the touch sensitive device 600. The resting fingers at positions 602 and 604 can have a dampening effect. That is, the data produced by the accelerometer and/or gyroscope for two identical touch inputs can be different if the user has one or more fingers resting on the touch screen at the time of the touch input. A dampening effect can similarly result from objects other than fingers resting on the touch screen at the time of the touch input.

To account for the dampening effect, the processor can apply a scaling factor or weight to the accelerometer and/or gyroscope values when additional objects are detected on the touch screen. In some cases, different scaling factors or weights can be applied to the different types of values or one type of values can be scaled or weighted while the other is not. For example, a scaling factor can be applied to the accelerometer values, but not the gyroscope values.

In some cases, the scaling factor or weight can be based on the distance from the user's touch to a nearest resting finger position. For example, in FIG. 6 the scaling factor can be based on the distance between position 606 and position 604, which is the closest resting finger to the touch input at position 606. The scaling factor or weight can alternatively be based on the distance from the user's touch to the furthest resting finger position. For example, in FIG. 6 the scaling factor can be based on the distance between position 606 and position 602, which is the furthest resting finger to the touch input at position 606. In some cases, the scaling factor or weight can be based on the distance to other positions, such as a position equidistant to the resting finger positions. For example, applying this scaling factor to FIG. 6, the scaling factor can be based on the position 608, which is between resting finger positions 602 and 604. Alternatively, the scaling factor or weight can be based on an average of the distances from the user's touch input to the one or more resting finger positions. For example, in FIG. 6 the scaling factor can be based on an average of the distance between positions 606 and 602 and positions 606 and 604. Additionally, other distances and/or factors can be used to determine the scaling factor or weight.

Device position can also impact the accuracy of an estimated velocity value. For example, some device cases alter the position of a resting device, such as by orienting the device at a 30 degree angle. FIG. 7 illustrates an example touch screen device 702 that is resting on a stand 704 such as a foldable cover. A sensor 706 can detect the presence of the attached stand 704. The sensor 706 can be a button depressed by the stand 704, a Hall Effect magnetic field sensor detecting a magnet in the stand 704, or other suitable sensor. When the sensor 706 is triggered, the processor can identify a device position category that tunes or selects the algorithm for processing touch inputs in that particular position. For example, when the device 702 is resting on the stand 704, accelerometer readings associated with touch input may be more sensitive than when the device is resting on a solid surface. The associated algorithm can process the input from the accelerometer accordingly. For example, when a stand 704 is attached, the device position category can indicate a 25% increase in velocity across the board. Other device position categories include flat, ranges of angles, horizontal orientation, vertical orientation, in a cover, on a soft surface, on a hard surface, and so forth.

Additional data inputs can also aid in improving the accuracy of an estimated velocity value. The change in size over time of the touch input can be an indication of the amount of pressure applied to the screen. For example, if there is very little change in the touch input footprint, it may be that the user applied very little force. FIG. 8 illustrates an example progression over time of a touch input. The processor can simulate pressure and estimate velocity of a touch input at least in part by analyzing the rate of change of the touch input. The initial location of the touch input 802 is very small, but as the user continues to press their finger, for example, on the touch screen, the touch input changes to a series of larger areas 804, 806, 808, then contracts over time to zero. The processor can analyze the rate of change to determine how fast, hard, and/or with how much force the user is applying the touch input. The processor can assign discrete steps of size, shape, and/or time and determine the amount of time that passes between each step. The processor can analyze the shape of the touch input and how the shape changes over time. The processor can also analyze changes in position and/or the center of the area of the touch input. The algorithm for processing and estimating the force or velocity or pressure of the touch input can take in to account all or part of these factors. The particular subset of factors that the processor considers can be based on a particular application or user interface element to which the touch input is directed.

Input history can also be used as a factor in generating an estimated velocity value. In some configurations, the system can maintain a history of touch input data. The stored data can be raw data, such as values from the accelerometer and/or gyroscope, or calculated values such as generated estimated velocity values. The history can include data over a predetermined period of time and/or with respect to a particular input location. For example, the history can include accelerometer and gyroscope data corresponding to a touch input location over a two second period of time.

In some cases, the input history can be used to filter and/or scale values that are inconsistent with the input history. For example, if the input history includes a sequence of very low velocity touch inputs and then one touch input that is perceived to be of significantly greater velocity, the system can infer that the high velocity touch input value is an anomaly. The system can have a variety of responses to the detected anomalous value, such as ignoring the value or scaling the value such that it matches the other values in the input history. In some configurations the anomaly detection and/or response action can be customized to the application using the data. For example, if the application using the velocity data is a virtual instrument application, it may be desirable to detect touch input values that vary by more than a predefined threshold value. This can be based on the theory that a user who is playing a sequence of quiet notes is unlikely to intend to include a single very loud note. In this case, the system can be configured to scale the touch input value or cap it based on the input history.

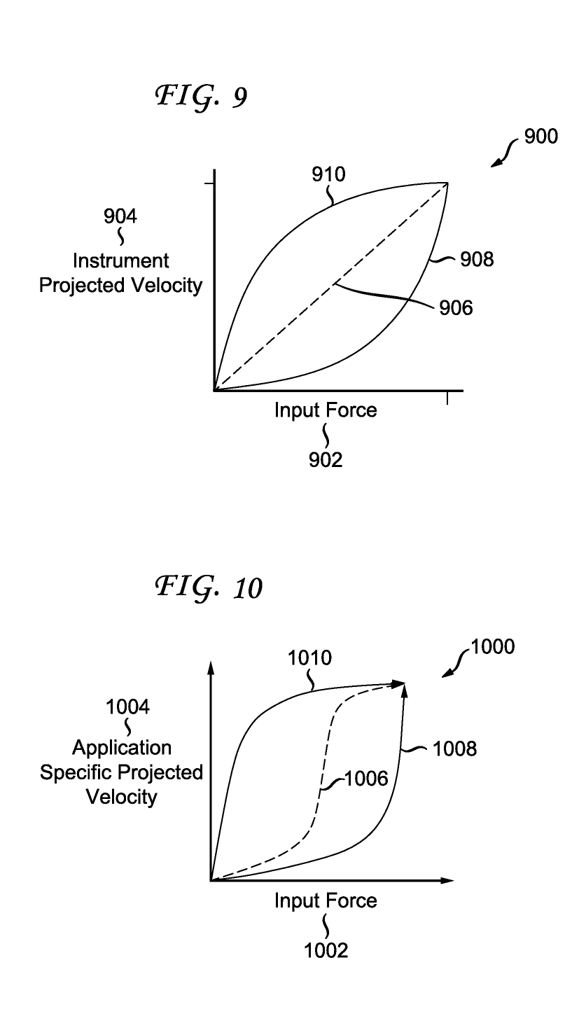

After generating an estimated velocity value, the value can be mapped and/or scaled as appropriate for the application requesting the value. For example, if the application is using the data to simulate virtual instruments the estimated velocity has a different meaning for different instrument types. Therefore, the estimated velocity values can be mapped to different velocity curves based on the use case. For example, FIG. 9 illustrates a chart 900 of a first exemplary velocity curve 906. The system receives a touch input and generates a corresponding estimated velocity. As the touch input force 902 increases the generated estimated velocity also increases, as illustrated by curve 908. The estimated velocity is then projected based on the application specific velocity curve 906 to generate an application specific projected velocity. In FIG. 9, the application specific velocity curve is the linear projection 906, which can be used to map the estimated velocity to a corresponding instrument projected velocity 904, such as MIDI standard values, as illustrated by curve 910. The projected values are then supplied as input to the virtual instrument algorithm.

FIG. 10 illustrates a second exemplary velocity curve used to map a touch input to an application specific velocity, such as for a virtual instrument. The system measures input force 1002, represented by the input force curve 1008, and processes that input force 1002 according to an algorithm to achieve an application specific projected velocity, represented by the resulting force curve 1010. The projected velocity is generated based on an application specific velocity curve 1006. A point on the input force curve 1008 translates to a corresponding point on the application specific projected velocity curve 1010. This example chart 1000 illustrates that smaller amounts of input force are extremely sensitive and a very soft range of input forces translates to a wide variety of resulting force readings. This can be useful for representing an instrument such as a piano or a guitar. Additional instruments can have different curves to reflect the characteristics of those instruments. For example, a piano may have a very expressive or variable low and middle force range, while the high force range may be less expressive. Drums may have a less expressive low force range, but a very expressive high force range. These curves can vary based on the orientation of the device, the type of user input, a user playing profile, metadata describing music a user is playing, and so forth. Additionally, the curves can be continuous or discrete. These principles can be applied to non-musical touch inputs as well, such as scientific instrumentation, art applications, or video games.

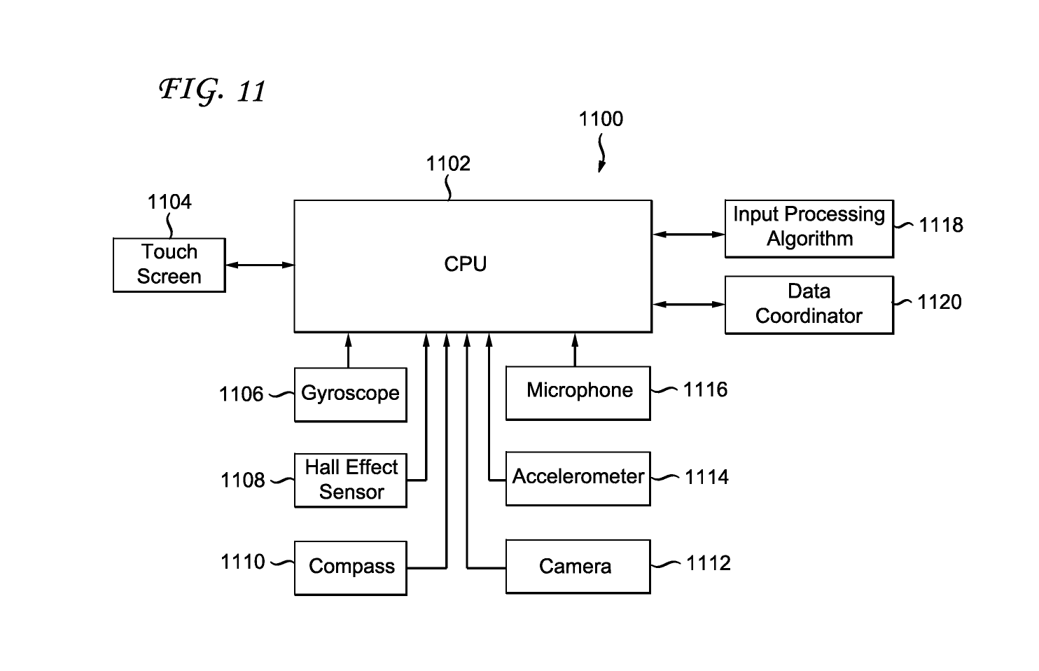

FIG. 11 illustrates a block diagram of some components of an example touch screen device 1100. The touch screen device 1100 includes a CPU 1102 and a touch screen 1104. The CPU receives various inputs from one or more other sensors such as a gyroscope 1106, a Hall Effect sensor 1108, a compass 1110, a camera 1112, an accelerometer 1114, and a microphone 1116. The CPU 1102 passes at least part of the inputs to an input processing algorithm 1118 according to a data coordinator 1120 that ensures that the data considered is sufficiently associated with a particular touch input received via the touch screen 1104. The system can use input from the camera 1112, for example, to estimate how fast visible portions of the user's arms or hands are moving and consider that estimated speed as part of the input processing algorithm 1118 to estimate pressure, velocity, or force applied to the touch screen 1104. The system can consider input from the microphone 1116 as part of the input processing algorithm 1118. For example, when the touch input occurs on the touch screen 1104 near the microphone 1116, the type, volume, duration, and quality of the sound of the user's finger tapping the touch screen 1104 can provide valuable information indicating how forceful the touch input was. The system can adjust how sound input is processed based on the distance of the touch from the microphone 1116 and/or based on acoustic propagation characteristics of the device 1100 between the location of the touch input and the microphone 1116 and/or the air around the device 1100.

The system can adapt any or all of these settings for processing inputs based on a particular user profile. For example, the system can learn a playing style of particular user automatically and adapt the algorithm based on how that user plays. Alternatively, the user can provide explicit feedback, such as by modifying a set of automatically generated or default settings, to change the algorithm.

This disclosure provides methods of reading data from hardware connected to a touch sensitive device, such as accelerometer, gyroscope, and magnetometer, to enhance estimated velocity calculations and to translate the estimated velocity values to application specific velocity values. One aspect detects if a touch-sensitive device is in a commonly known case, by detecting its resting position and angles, and adjusts performance characteristics for that device. Furthermore, this aspect can include detecting a commonly known case by detecting the presence of a magnet within the case, using a Hall Effect sensor or magnetometer. This aspect can also detect that a case is being used on the touch-sensitive device if shielding is detected, because a compass is not able to function properly. A second aspect can utilize data from an accelerometer and data from a gyroscope to estimate velocity input on a touch-sensitive virtual instrument. The accelerometer and gyroscope are used to filer out unwanted velocity input values. A third aspect can scale velocity of touch inputs based on user playing characteristics. For example, if a system detects that a user wants to play a quiet passage, the system will keep all values in a quiet range and not allow volume outliers. The system can follow a detector velocity curve. In a fourth aspect, the system can allow a user to shake or tap the device to influence playback. For example, when playing a virtual guitar the user can shake or tap the device with an open palm to provide a whammy bar effect based on input from the touch screen and the various sensors. The severity of the whammy bar effect can be based on the readings from the various sensors.

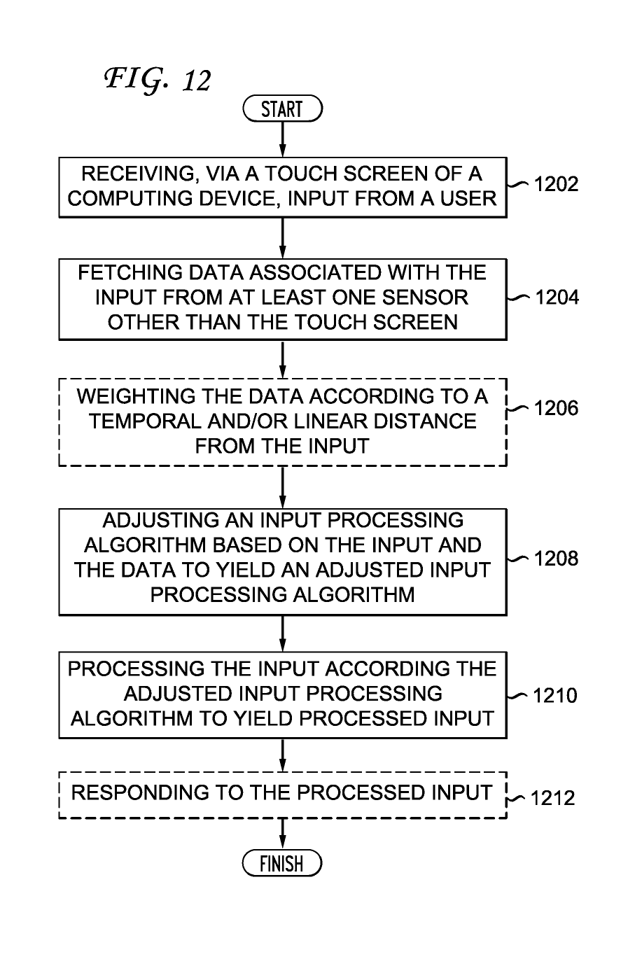

Having disclosed some basic system components and concepts, the disclosure now turns to the exemplary method embodiment shown in FIG. 12. For the sake of clarity, the method is discussed in terms of an exemplary system 100 as shown in FIG. 1 configured to practice the method. The steps outlined herein are exemplary and can be implemented in any combination thereof, including combinations that exclude, add, or modify certain steps.

The system 100 receives, via a touch screen of a computing device, input from a user (1202). If the touch screen is not pressure-sensitive, but the input is directed to a currently running application that simulates pressure-sensitive input, the system can estimate, via the adjusted input processing algorithm, a pressure of the input on the touch screen based on the data. The input can be touch input and can include as part of the input and/or as metadata describing the input a size of the touch input, a shape of the touch input, and/or rate of change of the touch input. Then the system 100 fetches data associated with the input from at least one sensor other than the touch screen (1204). The sensor can be an accelerometer, a gyroscope, a microphone, a Hall Effect sensor, a compass, an ambient light sensor, a proximity sensor, a camera, and/or a positioning system.

The system 100 can optionally weight the data according to a temporal distance from the input (1206). The data can be associated with the input based on a temporal relationship, i.e. how much time passes between the input and when the data was created or received. The system can weight the data according to a temporal and/or linear distance from the input. For example, if the data occurs simultaneously with or substantially simultaneously with the input, then the system can assign a greater weight to the data. Conversely, if the data occurs much later than the input, then the system can assign a much smaller weight to the data. Applying the same concept to physical positioning, the system can weight the data for the input according to a first position of the input on the touch screen, a second position of the accelerometer, and a third position of the gyroscope.

The system 100 adjusts an input processing algorithm based on the input and the data to yield an adjusted input processing algorithm (1208). The adjusted input processing algorithm can estimate a velocity of the input and filter out invalid inputs. In one aspect, the system identifies a position category based on the data before adjusting the input processing algorithm and, instead of adjusting the input processing algorithm, the system can select a predefined input processing algorithm as the input processing algorithm according to the device position category. The device category can include horizontal, vertical, with an attached cover, without a cover, and a range of angles.

The system 100 processes the input according the adjusted input processing algorithm to yield processed input (1210). Processing the input can include mapping the input to one of a range of input velocities. The system can process the input according to a user interface element to which the input is directed, and can process the input differently for different user interface elements. Metadata associated with the user interface element can determine how the system processes the input. The system 100 can optionally respond to the processed input (1212). For example, the system can control a software application in response to the input. In a musical instrument application such as a piano application, the system can respond to the processed input by outputting a modified sound that simulates how an input like the user-provided input would sound on an actual piano.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A method of processing user input, the method comprising:
receiving, via a touch screen of a computing device, input from a user;
fetching data associated with the input from an accelerometer and a first sensor, wherein the first sensor is selected from the group consisting of a gyroscope, a microphone, a Hall Effect sensor, a compass, an ambient light sensor, a proximity sensor, a camera, and a positioning system;
adjusting an input processing algorithm based on the input and the data to yield an adjusted input processing algorithm; and
processing the input according to the adjusted input processing algorithm.

2. The method of claim 1, wherein the adjusted input processing algorithm estimates a velocity of the input.

3. The method of claim 1, wherein the adjusted input processing algorithm filters out invalid inputs.

4. The method of claim 1, wherein the data is associated with the input based on a temporal relationship.

5. The method of claim 4, further comprising weighting the data according to a temporal distance from the input.

6. The method of claim 1, further comprising scaling the data with a scaling factor when more than one touched location exists on the touch screen.

7. The method of claim 6, wherein the scaling factor is determined by a distance between touched locations on the touch screen.

8. A system for processing user input, the system comprising:
a processor;
a touch screen;
an accelerometer;
a gyroscope; and
a memory storing instructions for controlling the processor to perform steps comprising:
receiving, via a touch screen, input from a user;
fetching data associated with the input from the accelerometer and the gyroscope;
adjusting an input processing algorithm based on the input and the data to yield an adjusted input processing algorithm; and
processing the input according to the adjusted input processing algorithm.

9. The system of claim 8, wherein the touch screen is not pressure-sensitive, wherein the input is directed to a currently running application that simulates pressure-sensitive input, and wherein the adjusted input processing algorithm estimates a pressure of the input on the touch screen based on the data.

10. The system of claim 9, wherein the input controls the application.

11. The system of claim 8, wherein the input is a touch input and comprises at least one of a size of the touch input, a shape of the touch input, and rate of change of the touch input.

12. The system of claim 8, wherein the memory stores instructions for further controlling the processor to perform steps comprising, prior to adjusting the input processing algorithm:
identifying a device position category for the system based on the data; and
selecting a predefined input processing algorithm as the input processing algorithm according to the device position category.

13. The system of claim 12, wherein the device position category comprises at least one of horizontal, vertical, with an attached cover, without a cover, and a range of angles.

14. The system of claim 8, wherein the memory storing instructions further comprises scaling the data with a scaling factor when more than one touched location exits on the touch screen.

15. The system of claim 14, wherein the scaling factor is determined by a distance between touched locations on the touch screen.

16. A non-transitory computer-readable storage medium storing instructions which, when executed by a computing device, cause the computing device to process user input, the instructions comprising:
receiving, via a touch screen of a computing device, input from a user;
fetching data associated with the input from at least one sensor other than the touch screen;
adjusting an input processing algorithm based on the input and the data to yield an adjusted input processing algorithm; and
processing the input according to the adjusted input processing algorithm.

17. The non-transitory computer-readable storage medium of claim 16, wherein processing the input according the adjusted input processing algorithm comprises mapping the input to one of a range of input velocities.

18. The non-transitory computer-readable storage medium of claim 16, wherein processing the input is further performed according to a user interface element to which the input is directed.

19. The non-transitory computer-readable storage medium of claim 16, wherein the adjusted input processing algorithm processes input differently for different user interface elements.

20. The non-transitory computer-readable storage medium of claim 16, wherein adjusting the input processing algorithm is further based on metadata associated with the user interface element.

21. The non-transitory computer-readable storage medium of claim 16, further comprising scaling the data with a scaling factor when more than one touched location exists on the touch screen.

22. The non-transitory computer-readable storage medium of claim 21, wherein the scaling factor is determined by a distance between touched locations on the touch screen.

23. A system comprising:
a processor;
a non-pressure sensitive touch screen;
an accelerometer;
a gyroscope; and
a storage device storing an application, wherein, when the application executes, the application controls the processor to perform steps comprising:
receiving, via the non-pressure sensitive touch screen, input from a user;
fetching data associated with the input from the accelerometer and the gyroscope;
adjusting an input processing algorithm based on the input and the data to yield an adjusted input processing algorithm;
processing the input according to the adjusted input processing algorithm to yield processed input; and
responding to the processed input.

24. The system of claim 23, wherein the application further controls the processor to weight the data for the input according to a first position of the input on the touch screen, a second position of the accelerometer, and a third position of the gyroscope.

25. The system of claim 23, wherein the adjusted input processing algorithm estimates a velocity of the input.

26. The system of claim 23, further comprising at least one additional sensor comprising at least one of a microphone, a Hall Effect sensor, a compass, an ambient light sensor, a proximity sensor, a camera, and a positioning system.

27. The system of claim 26, wherein the application further controls the processor to fetch additional data associated with the input from the at least one additional sensor, and adjust the input processing algorithm further based on the additional data.

28. The system of claim 23, wherein the adjusted input processing algorithm filters out invalid inputs.

29. The system of claim 23, wherein the data is associated with the input based on a temporal relationship.

30. The system of claim 29, wherein the application further controls the processor to weight the data according to a temporal distance from the input.
